(19) United States
(12) Patent Application Publication
(10) Pub. No.: US 2015/0246659 A1
(43) Pub. Date: Sep. 3, 2015

(54) CONNECTING APPARATUS FOR CONNECTING WIPER BLADE WITH WIPER ARM AND WIPER BLADE INCLUDING THE SAME

(71) Applicant: KCW Corporation, Daegu (KR)

(72) Inventor: Jin-Wan PARK, Daegu (KR)

(21) Appl. No.: 14/633,472

(22) Filed: Feb. 27, 2015

(30) Foreign Application Priority Data
Mar. 3, 2014 (KR) 10-2014-0024860

(51) Int. Cl. B60S 1/40

(52) U.S. Cl. CPC B60S 1/4009; B60S 2001/4035

(57) ABSTRACT

Disclosed are a connecting device and a wiper blade for connecting a wiper arm to a wiper blade having a connection holder formed therein. The connecting device and wiper blade include: an adaptor which is assembled to the wiper blade and is coupled to the wiper arm; and a covering member which covers a portion of an opening formed in the connection holder. The covering member is rotatable between a fixing position and a release position about a rotation axis. A top surface of the covering member formed between the rotation axis and a longitudinal end of the connection holder is pressed, so that the covering member is rotated from the fixing position to the release position.

### CROSS REFERENCE TO RELATED APPLICATIONS

Priority is claimed under 35 U.S.C. §119 to Korean Patent Application No.: 10-2014-0024860, filed Mar. 3, 2014, the disclosure of which is incorporated herein by reference in its entirety.

### FIELD OF THE INVENTION

Embodiments may relate to a connecting device for connecting a wiper blade with a wiper arm, and the wiper blade including the same.

### BACKGROUND OF THE INVENTION

In general, a wiper blade removes impurities, snow, rain or the like when driving and prevents a driver's front sight from being deteriorated. As a motor drives a link apparatus connected to a wiper arm, the wiper blade performs a repetitive reciprocating action in a fan shape. The wiper of a vehicle is supported by the end of the wiper arm and contacts with a wiping surface. The wiper blade is connected to and supported by the hook of the wiper arm through a connection member. The hook is located at the end of the wiper arm and has a U-shape.

The wiper blade has an opening formed in the central portion thereof, and the wiper arm is inserted into the opening. Here, the opening is formed large enough for the wiper arm to be inserted thereinto. When the wiper arm is inserted into the opening, the cover is designed to cover a portion of the opening because impurities, rainwater, etc., permeate through an empty space that the wiper arm does not occupy in the opening. One end of the cover is connected to one end of the opening, and the connection portion may function as a rotation axis about which the cover rotates with respect to the opening. Therefore, the position of the cover may be converted into the fixing position and release position due to the rotation thereof about the rotation axis.

However, in the conventional wiper blade, for the purpose of converting the position of the cover into the release position from the fixing position, it is required to cause the cover to rotate by lifting up the opposite end of the rotation axis of the cover. Therefore, since the cover of the wiper blade is generally lifted up by using fingers, it is difficult to lift it up by inserting the fingers. Particularly, women with long fingernails may be damaged in her fingernails while lifting up the cover. Also, since a predetermined space into which the finger can be inserted is required between the cover and the wiper arm so as to lift up the cover, a gap should be externally created.

### SUMMARY OF THE INVENTION

One embodiment is a wiper blade. A connecting device and the wiper blade according to the embodiment of the present invention are for connecting a wiper arm to the wiper blade having a connection holder formed therein. The connecting device includes: an adaptor which is assembled to the wiper blade and is coupled to the wiper arm; and a covering member which covers a portion of an opening formed in the connection holder. The covering member is rotatable between a fixing position and a release position about a rotation axis. A top surface of the covering member formed between the rotation axis and a longitudinal end of the connection holder is pressed, so that the covering member is rotated from the fixing position to the release position.

In the connecting device, the covering member 30 and 130 may be rotated from the fixing position to the release position when a magnitude of moment by a force pressing the top surfaces 31 and 131 is greater than a predetermined value.

In the connecting device, the covering members 30 and 130 may further include catching portions 33 and 133 which are formed on at least one longitudinal end thereof. The connecting device may further include a corresponding catching portion 41 which is formed on at least one of one longitudinal end and a width direction inside of the connection holder 50 and is mutually caught by the catching portions 33 and 133.

In the connecting device, the catching portions 33 and 133 may be formed to protrude outwardly from the covering members 30 and 130 or may be formed concave. The corresponding catching portion 41 may be formed concave or protruding in correspondence with the catching portions 33 and 133.

The connecting device may further include a first protrusion 12 formed therein. The first protrusion 12 may be fitted in first coupling grooves 32 and 132 formed on at least one side of the covering members 30 and 130.

The connecting device may further include a second protrusion 13 formed therein. The second protrusion 13 may support the top surfaces 31 and 131 of the covering members 30 and 130.

In the connecting device, the top surfaces 31 and 131 of the covering members 30 and 130 may have an arch shaped cross section viewed from the longitudinal direction thereof.

In the connecting device, the connection holder 50 may further include a central axis 11 formed therewithin. The adaptor 20 may include an axis coupling recess 21 which is coupled to the central axis 11.

In the connecting device, the wiper arm “A” may have a one U-shaped end which is coupled to the wiper blade 1. The adaptor 20 may further include a U-hook coupler 22 to which the U-shaped end of the wiper arm “A” is coupled.

In the connecting device, the cross section formed by cutting the first protrusion 12 in a longitudinal direction of the wiper blade may have a non-circular shape. The first protrusion 12 may have an outer peripheral surface tapered in the fitting direction of the covering member 30.

### BRIEF DESCRIPTION OF THE DRAWINGS

FIG. 1 is a perspective view showing a wiper arm and a wiper blade to which a connecting device has been applied in accordance with a first embodiment;

FIGS. 2a and 2b are exploded perspective views showing that the wiper blade and the wiper arm of FIG. 1 have been separated from each other;

FIG. 3 is a cross sectional view formed by cutting the connecting device according to the first embodiment in a longitudinal direction thereof;

FIGS. 4a and 4b are a bottom perspective view and a side view of a covering member according to the first embodiment, respectively;

FIG. 5 shows a step in which the wiper arm is coupled to the wiper blade to which the connecting device has been applied according to the first embodiment;

FIG. 6 is a cross sectional view formed by cutting the connecting device according to a second embodiment in a longitudinal direction thereof; and

FIGS. 7a and 7b are a bottom perspective view and a side view of a covering member according to the second embodiment, respectively.

### DETAILED DESCRIPTION OF THE INVENTION

An embodiment of the present invention will be described in detail with reference to the accompanying drawings. In the components of the present invention, detailed descriptions of what can be clearly understood and easily carried into practice through a prior art by those skilled in the art will be omitted to avoid making the subject matter of the present invention unclear.

### FIRST EMBODIMENT

Hereafter, first, a connecting device according to a first embodiment and a wiper blade including the connecting device will be described.

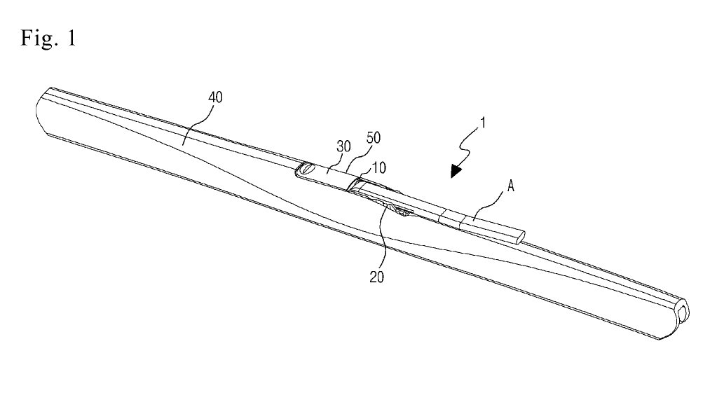

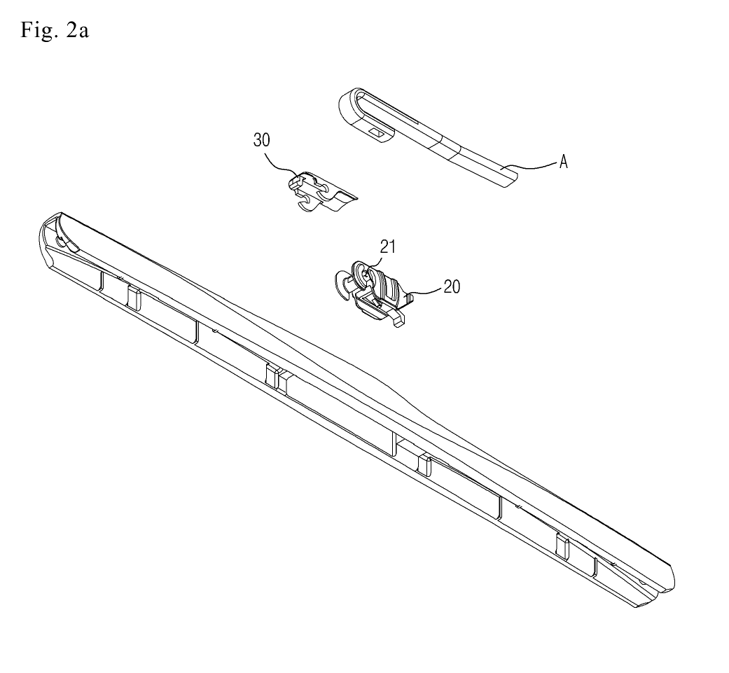

FIG. 1 is a perspective view showing a wiper arm and a wiper blade to which a connecting device has been applied in accordance with a first embodiment. FIGS. 2a and 2b are exploded perspective views showing that the wiper blade and the wiper arm of FIG. 1 have been separated from each other.

Referring to FIGS. 1 to 2b, a wiper blade 1 including the connecting device according to the first embodiment is formed by assembling a wiper strip (not shown) wiping a glass surface of a vehicle, a yoke lever (not shown) supporting the wiper strip, a main lever 40 connected to the yoke lever, and a connection holder 50 formed in the central portion of the main lever 40.

The wiper strip (not shown) contacts directly with and wipes the glass surface of the vehicle and removes impurities on the glass surface. The wiper strip is made of an elastic material like rubber, or an elastic composite material. The yoke lever (not shown) supports directly the wiper strip. One or two pairs of the yoke levers may be provided. In the yoke lever, the portion supporting the wiper strip may have a yoke shape.

The connecting device according to the first embodiment may include an adaptor 20 to which a wiper arm “A” is directly coupled and a covering member 30 which covers a portion of an opening 10 formed in the connection holder 50 of the main lever 40. The adaptor 20 is coupled to a central axis 11 formed within the connection holder 50 of the wiper blade 1. The covering member 30 is rotatable between a fixing position and a release position about a rotation axis.

The main lever 40 receives the wiper strip and the yoke lever and is coupled to the wiper arm “A”. The main lever 40 applies a pressing force applied from the wiper arm “A” to the yoke lever or the wiper strip. The yoke lever transmits the pressing force to the wiper strip.

The opening 10 is formed in the connection holder 50 of the main lever 40. The connection holder 50 is located approximately at the center of the main lever 40 and has the opening 10 for coupling to the wiper arm “A”. Also, the connection holder 50 may be formed to have parallel side walls. The corner of the opening 10 may be rounded, thereby transmitting stress focused on the connection holder 50 to the entire main lever 40.

The central axis 11 traversing the opening 10 in the width direction of the wiper blade 1 may be formed within and in the direction of the width of the connection holder 50 having the opening 10 formed therein. The adaptor 20 to which the wiper arm “A” is directly coupled may be assembled to the central axis 11. Also, the covering member 30 covering a portion of the opening 10 may be assembled to the connection holder 50.

A first protrusion 12 which is coupled to a first coupling groove 32 of the covering member 30 and a second protrusion 13 which supports a top surface 31 of the covering member 30 may be formed within the connection holder 50 in which the opening 10 has been formed. Also, a corresponding catching portion (not shown) by which a protrusion catching portion 33b of the covering member 30 is caught may be formed at one of both longitudinal inner ends of the connection holder 50.

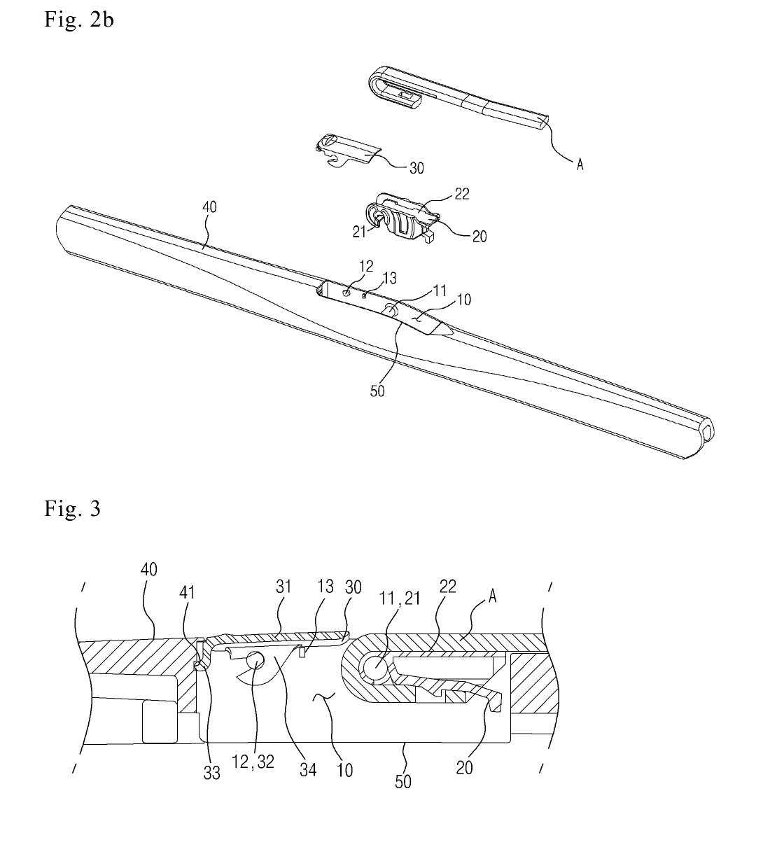

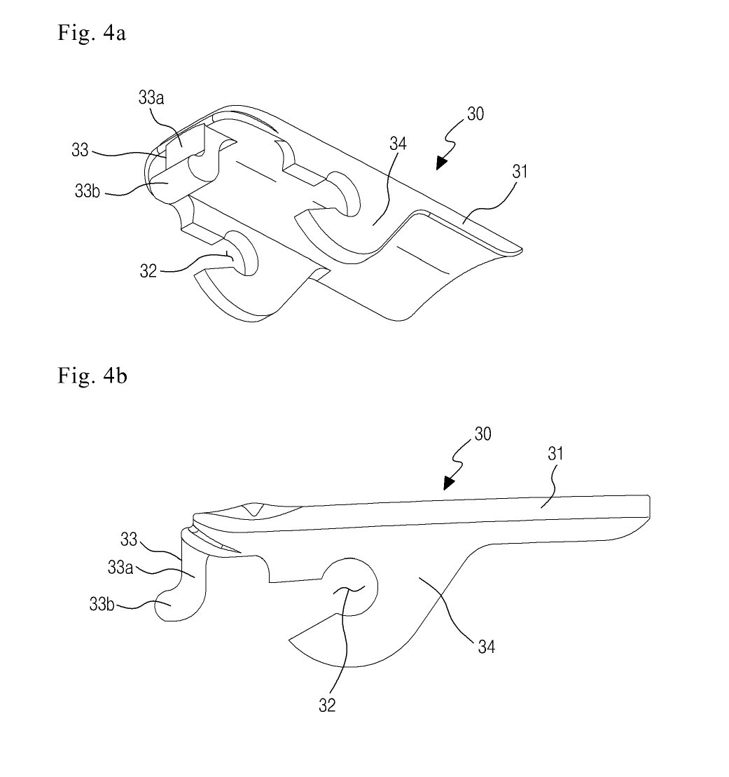

FIG. 3 is a cross sectional view formed by cutting the connecting device according to the first embodiment in a longitudinal direction thereof. FIGS. 4a and 4b are a bottom perspective view and a side view of the covering member according to the first embodiment, respectively.

Referring to FIGS. 3 to 4b, the adaptor 20 is formed in the opening 10 of the wiper blade 1 and is coupled to the wiper arm “A”. Specifically, the adaptor 20 is assembled to the connection holder 50 of the main lever 40 and is directly connected to the wiper arm “A”. An axis coupling recess 21 formed approximately in the center of the adaptor 20 is coupled to the central axis 11 formed within the connection holder 50 of the main lever 40. As a result, the adaptor 20 is rotatably assembled to the main lever 40, and the wiper arm “A” is allowed to be coupled to the adaptor 20. The adaptor 20 may include a U-hook coupler 22 having a curved surface for receiving the U-hook type wiper arm “A”. The wiper arm “A” may be selectively coupled to the U-hook coupler 22 in accordance with the size of the wiper arm “A”.

The U-hook type wiper arm “A” is already known to the public. Therefore, a detailed description on the coupling of the wiper blade and the U-hook type wiper arm “A” will be omitted.

As shown in FIGS. 3 to 4b, the covering member 30 includes the top surface 31 which covers a portion of the opening 10 of the main lever 40, a side coupler 34 which extends downward from both width direction ends of the top surface 31 and has the first coupling groove 32 being coupled to the first protrusion 12, and a catching portion 33 which extends downward from a longitudinal end of the covering member 30. The covering member 30 may be made of a resin material. Therefore, the covering member 30 is easy to manufacture by an injection molding method.

The top surface 31 of the covering member 30 covers a portion of the opening 10 of the main lever 40. The shape of the top surface 31 may be rectangular and may be changed according to the shape of the opening 10 without being limited to this. When viewed in the longitudinal direction of the covering member 30, the top surface 31 may be formed to have an arch shape of which the height is reduced toward the both width direction ends to the center thereof. Therefore, it is possible to increase a resistance to the moment or force applied to the top surface 31 of the covering member 30.

The side coupler 34 may extend downward from the both width direction ends of the top surface 31. The side coupler 34 may have the first coupling groove 32 which is coupled to the below-described first protrusion 12 formed within the connection holder 50 of the main lever 40.

The catching portion 33 may be formed to extend downward from the longitudinal end of the covering member 30. The catching portion 33 includes an extension part 33a which extends downward from the covering member 30, and the protrusion catching portion 33b which is formed to protrude outwardly from the extension part 33a to the outside of the covering member 30. The protrusion catching portion 33b is caught by a corresponding catching portion 41 of the main lever 40. At the fixing position, the catching portion 33 of the covering member 30 is engaged with the corresponding catching portion 41 of the main lever 40. Therefore, until an external force greater than a predetermined magnitude is applied to the top surface 31 of the covering member 30, the covering member 30 may be placed at the fixing position. When the external force greater than a predetermined magnitude is applied to the top surface 31 between the first coupling groove 32 and the catching portion 33, the catching portion 33 is separated from the corresponding catching portion 41, and then the covering member 30 rotates to the release position. Meanwhile, the catching portion 33 according to the first embodiment is formed to include the protrusion catching portion 33b, and the corresponding catching portion 41 is formed concave. However, there is no limit to this. For example, the catching portion 33 may be formed concave, and the corresponding catching portion 41 may be formed to protrude.

In the next place, how the main lever 40 and the connecting device are coupled to each other and the operation of the covering member 30 will be described.

As shown in FIGS. 3 to 4b, the central axis 11 of the main lever 40 is provided in order that the adaptor 20 is connected to the connection holder 50 of the main lever 40. The central axis 11 may be made of a tougher and more flexible material than a conventional material. For this reason, the central axis 11 can be prevented from being broken due to friction between the wiper arm “A” and the central axis 11. The central axis 11 is one of the portions to which the most torsional stress and moment are applied when the wiping is. Accordingly, the central axis 11 is made of a tougher and more flexible material, thereby increasing a resistance to the torsional moment and stress applied to the connection holder 50. The central axis 11 is more flexible than the main lever 40. Therefore, although the central axis 11 is inserted into the inside of the connection holder 50, the external appearance of the connection holder 50 does not change. Accordingly, there is no influence on the appearance, so that when a fin is formed on the outside of the main lever 40, the integrality of shape can be maintained. As a result, when the main lever 40 is made of a resin material, the central axis 11 is also able to reinforce the rigidity of the main lever 40.

As shown in FIGS. 3 to 4b, the first protrusion 12 of the main lever 40 is fitted in the first coupling groove 32, and then functions as a rotation axis of the covering member 30. The cross section formed by cutting the first protrusion 12 in the longitudinal direction of the wiper blade has a non-circular shape. The non-circular cross section of the first protrusion 12 has an outer peripheral surface tapered in the fitting direction of the covering member 30. The first protrusion 12 is inserted into the circular hole-shaped opening of the first coupling groove 32, and then the covering member 30 is hereby coupled to the opening 10 of the main lever 40. As viewed in the direction in which the first protrusion 12 is inserted into the circular hole-shaped opening of the first coupling groove 32, the tapered cross section of the first protrusion 12 is formed such that a gap difference between the first protrusion 12 and the circular hole-shaped opening is reduced toward the front end from the rear end of the first protrusion 12. In other words, in FIG. 3, the width of the one end of the first protrusion 12, which is closer to the first coupling groove 32, is less than the width of the circular hole-shaped opening of the first coupling groove 32. In a state where the first protrusion 12 is completely fitted in the first coupling groove 32, the width of the other end of the first protrusion 12, which is located at the opening of the first coupling groove 32, may be substantially the same as or slightly greater than the width of the opening. After the first protrusion 12 is fitted in the first coupling groove 32, when the covering member 30 rotates about the first protrusion 12, i.e., the rotation axis, in the direction of the fixing position (clockwise in FIG. 3), the other tapered end of the first protrusion 12 cannot be separated through the width of the opening. Therefore, the covering member 30 is not easily separated from the main lever 40.

The second protrusion 13 supports the top surface 31 of the covering member 30. The second protrusion 13 supports under the top surface 31, thereby preventing the rotational movement of the covering member 30 in such a manner as to allow the covering member 30 moves only to the release position (counterclockwise in FIG. 3). The covering member 30 of the wiper blade shown in FIG. 3 is prevented from moving clockwise in the cross sectional view. That is, due to the second protrusion 13, the covering member 30 at the fixing position is allowed to move only to the release position counterclockwise.

Referring to FIG. 3, the top surface 31 of the covering member 30 at the fixing position becomes in approximate parallel with the wiper blade 1 and covers a portion of the opening 10 of the connection holder 50. At the fixing position, the protrusion catching portion 33b of the covering member 30 is caught by the corresponding catching portion 41 of the connection holder 50. Therefore, the top surface of the protrusion catching portion 33b may be caught by the top surface of the corresponding catching portion 41. Therefore, the covering member 30 is allowed to move only in the direction from the fixing position to the release position by the second protrusion 13 and the corresponding catching portion 41 and is prevented from rotating in the opposite direction thereto.

Next, how the wiper arm “A” is coupled to the wiper blade 1 will be described.

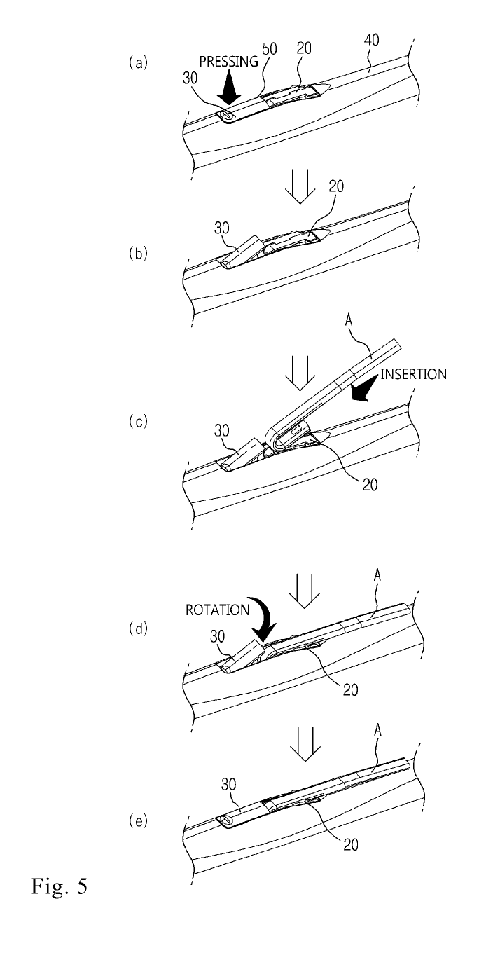

FIG. 5 shows a step in which the wiper arm is coupled to the wiper blade to which the connecting device has been applied according to the first embodiment.

In (a) of FIG. 5, an external force is applied to the covering member 30 at the fixing position. Referring to FIGS. 3 to 5, in order to move the covering member 30 from the fixing position to the release position, the external force is applied between the first coupling groove 32 and the protrusion catching portion 33b of the covering member 30. Therefore, the covering member 30 rotates about the central axis of the first coupling groove 32 and is placed at the release position. It is shown in (b) of FIG. 5 that the covering member 30 is placed at the release position. It is shown in (c) of FIG. 5 that in the state where the covering member 30 is at the release position, the wiper arm “A” is coupled to the adaptor 20. As shown in (c) of FIG. 5, one end of the wiper arm “A” may be inserted into and coupled to the adaptor 20. It is shown in (d) of FIG. 5 that, after the wiper arm “A” is coupled to the adaptor 20, the covering member 30 rotates from the release position to the fixing position. It is shown in (e) of FIG. 5 that the wiper arm “A” is coupled to the connection holder “Y” of the main lever 40, and the covering member 30 is located at the fixing position.

Accordingly, for the purpose of coupling the wiper arm “A” to the wiper blade according to the embodiment of the present invention, it is possible to easily place the covering member 30 at the release position by pressing the top surface 31 of the covering member 30. Therefore, there is no need to insert the finger between the covering member 30 and the adaptor 20 so as to place the covering member 30 at the release position and no need to create the gap for insertion of the finger. As a result, the appearance is improved.

### SECOND EMBODIMENT

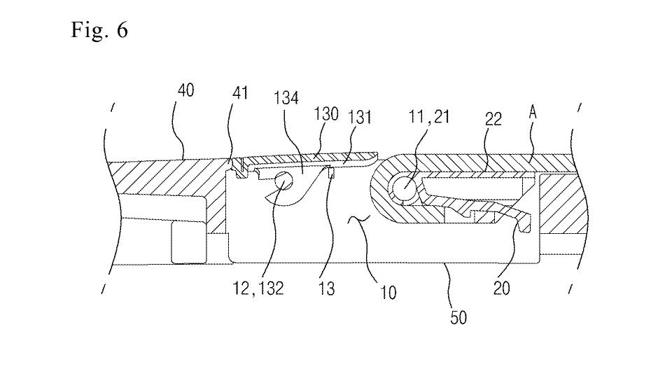

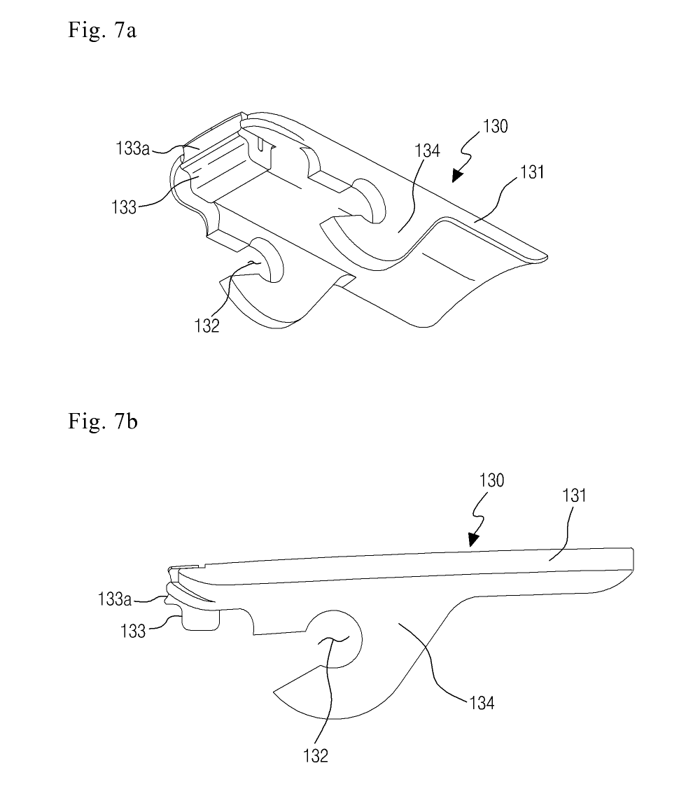

FIG. 6 is a cross sectional view formed by cutting the connecting device according to a second embodiment in a longitudinal direction thereof. FIGS. 7a and 7b are a bottom perspective view and a side view of a covering member according to the second embodiment, respectively.

Referring to FIGS. 6 to 7b, a covering member 130 according to the second embodiment includes a top surface 131 which covers a portion of an opening 110 of a main lever 140, a side coupler 134 which extends downward from both width direction ends of the top surface 131 and has a first coupling groove 132 being coupled to a first protrusion 112, and a catching portion 133 which extends downward from a longitudinal end of the covering member 130. The covering member 130 may be made of a resin material.

The top surface 131 of the covering member 130 covers a portion of the opening 110 of the main lever 140. The shape of the top surface 131 may be rectangular and may be changed according to the shape of the opening 110 without being limited to this. When viewed in the longitudinal direction of the covering member 130, the top surface 131 may be formed to have an arch shape of which the height is reduced toward the both width direction ends to the center thereof. Therefore, it is possible to increase a resistance to the moment or force applied to the top surface 131 of the covering member 130.

The side coupler 134 may extend downward from the both width direction ends of the top surface 131. The side coupler 134 may have the first coupling groove 132 which is coupled to the first protrusion 112 formed within a connection holder 150 of the main lever 140.

The catching portion 133 is formed on the longitudinal end of the covering member 130 and is caught by a corresponding catching portion 141 formed on one longitudinal end of the connection holder 150. A longitudinal outer surface 133a of the catching portion 133 may be formed concave corresponding to the corresponding catching portion 141. Therefore, at the fixing position, the catching portion 133 of the covering member 130 is engaged with the corresponding catching portion 141 of the main lever 140. Therefore, until the external force greater than a predetermined magnitude is applied to the top surface 131 of the covering member 130, the covering member 130 may be placed at the fixing position. When the external force greater than a predetermined magnitude is applied to the top surface 131 between the first coupling groove 132 and the catching portion 133, the catching portion 133 is separated from the corresponding catching portion 141, and then the covering member 130 rotates to the release position. Meanwhile, the catching portion 133 according to the second embodiment is formed concave, and the corresponding catching portion 141 is formed to protrude. However, there is no limit to this. For example, the catching portion 133 may be formed to protrude, and the corresponding catching portion 141 may be formed concave.

Meanwhile, in the covering members 30 and 130 of the connecting device according to the first and second embodiments, the corresponding catching portion 141 of the connection holder 150 is formed at one of both longitudinal inner ends of the connection holder 150. However, there is no limit to this. For example, unlike the first and second embodiments, the catching portions 33 and 133 of the covering members 30 and 130 may be formed at the other ends of the covering members 30 and 130. That is, with respect to the first protrusion 112, i.e., the rotation axis, the catching portions 33 and 133 may be formed on the opposite side to the position to which the external force is applied. Here, the corresponding catching portion 141 may be formed within the connection holder 150 in the width direction of the connection holder 150 such that the corresponding catching portion 141 is caught by the catching portions 33 and 133 formed on the other ends of the covering members 30 and 130. In other words, the positions of the catching portions 33 and 133 of the covering members 30 and 130 and the position of the catching portion 141 of the connection holder 150 are not fixed, and it is enough as long as the catching portions 33 and 133 and the catching portion 141 are positioned such that the covering members 30 and 130 can be placed at the fixing position until the external force greater than a predetermined magnitude is applied to the covering members 30 and 130. Therefore, the catching portions 33 and 133 may be formed on at least one of one and the other longitudinal ends of the covering members 30 and 130, and the corresponding catching portion 141 may be formed on one inner longitudinal end of the connection holder 150 or formed within the connection holder 150 in the width direction of the connection holder 150.

Also, the catching portions 33 and 133 may not protrude from or may not be concave on the covering members 30 and 130 of the present invention. The corresponding catching portion 141 of the main lever 140 may not be formed concave or may not protrude in such a manner as to correspond to the catching portions 33 and 133. For example, since the catching portions 33 and 133 are made of a resin material, the catching portions 33 and 133 may be elastically coupled to the corresponding catching portion 141 in an interference fit manner. Here, the catching portions 33 and 133 may exactly fit the corresponding catching portion 141 or may be slightly larger than the corresponding catching portion 141.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although the embodiments of the present invention were described above, these are just examples and do not limit the present invention. Further, the present invention may be changed and modified in various ways, without departing from the essential features of the present invention, by those skilled in the art. That is, the components described in detail in the embodiments of the present invention may be modified. Further, differences due to the modification and application should be construed as being included in the scope and spirit of the present invention, which is described in the accompanying claims.

What is claimed is:

1. A connecting device for connecting a wiper arm to a wiper blade having a connection holder formed therein, the connecting device comprising:
an adaptor which is assembled to the wiper blade and is coupled to the wiper arm; and
covering members which cover a portion of an opening formed in the connection holder,
wherein the covering members are rotatable between a fixing position and a release position about a rotation axis,
and wherein top surfaces of the covering members formed between the rotation axis and a longitudinal end of the connection holder are pressed, so that the covering members are rotated from the fixing position to the release position.

2. The connecting device of claim 1, wherein the covering members are rotated from the fixing position to the release position when a magnitude of moment by a force pressing the top surfaces is greater than a predetermined value.

3. The connecting device of claim 1, wherein the covering members further comprise catching portions which are formed on at least one longitudinal end thereof, and wherein the connecting device further comprises a corresponding catching portion which is formed on at least one of one longitudinal end and a width direction inside of the connection holder and is mutually caught by the catching portions.

4. The connecting device of claim 3, wherein the catching portions are formed to protrude outwardly from the covering members or are formed concave, and wherein the corresponding catching portion is formed concave or protruding in correspondence with the catching portions.

5. The connecting device of claim 1, further comprising a first protrusion formed therein, wherein the first protrusion is fitted in first coupling grooves formed on at least one side of the covering members.

6. The connecting device of claim 1, further comprising a second protrusion formed therein, wherein the second protrusion supports the top surfaces of the covering members.

7. The connecting device of claim 1, wherein the top surfaces of the covering members have an arch shaped cross section viewed from the longitudinal direction thereof.

8. The connecting device of claim 1, wherein the connection holder further comprises a central axis formed therewithin, and wherein the adaptor comprises an axis coupling recess which is coupled to the central axis.

9. The connecting device of claim 8,
wherein the wiper arm has a one U-shaped end which is coupled to the wiper blade,
and wherein the adaptor further comprises a U-hook coupler to which the U-shaped end of the wiper arm is coupled.

10. The connecting device of claim 1, wherein a cross section formed by cutting the first protrusion in a longitudinal direction of the wiper blade has a non-circular shape, and wherein the first protrusion has an outer peripheral surface tapered in the fitting direction of the covering member.

11. A wiper blade comprising the connecting device according to claim 1.
